(19) United States
(12) Patent Application Publication
(10) Pub. No.: US 2006/0120735 A1
(43) Pub. Date: Jun. 8, 2006

(54) Method to provide a user with an offer related to a used consumable

(75) Inventors: Christopher A. Adkins, Lexington, KY (US); Timothy L. Strunk, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/006,411

(22) Filed: Dec. 7, 2004

(51) Int. Cl. G03G 15/00; G03G 15/08

(52) U.S. Cl. 399/12; 399/27

(57) ABSTRACT

A method to provide a user with an offer relating to a used consumable includes associating the used consumable with the user, and, if desired, providing an offer to the user relating to the used consumable.

### BACKGROUND OF THE INVENTION

1. Field of the Invention

The present invention relates to the use of a consumable, and, more particularly, to a method to provide a user with an offer related to a used consumable, such as for example, a credit for unused imaging substance in the consumable.

2. Description of the Related Art

Returned consumables, such as ink or toner cartridges, often are not suitable for the most environmental friendly use of the returned consumable, i.e., through reuse, and therefore, the consumables are recycled. The reason for non-suitability may be because the user either waited too long to return the cartridge or continued trying to use the cartridge after it was essentially depleted. Either may significantly degrade the cartridge and present significant challenges in attempting to make the consumable available for successful reuse.

Also, when a consumable is determined or assumed to be defective jointly by the consumer and the manufacturer, then the consumable is often replaced in its entirety, even though only a portion of the imaging substance in the consumable has been successfully used.

Furthermore, cartridges with multiple imaging substance reservoirs, e.g., multiple ink/toner chambers, such as for example an ink jet tri-color printhead cartridge, can deplete a single color more significantly than the others, leaving the balance of the other colors effectively unusable.

### SUMMARY OF THE INVENTION

One embodiment of the present invention provides a user with an offer related to a used consumable, such as for example, a credit for unused imaging substance in the consumable.

In one embodiment, the invention is directed to a method to provide a user with an offer related to an unused imaging substance in a consumable, including associating the consumable with the user; determining an amount of unused imaging substance in the consumable; and, if desired, providing an offer to the user related to the unused imaging substance in the consumable.

Another embodiment is directed to a system to provide a user with an offer related to unused imaging substance in a consumable having a memory. The system includes a fixture configured for receiving the consumable. A processor device is communicatively coupled to the memory of the consumable. The processor device executes program instructions to retrieve information pertinent to providing to the user the offer related to the unused imaging substance in the consumable. A database is communicatively coupled to the processor device for receiving the information from the processor device.

In another embodiment, the invention is directed to a consumable for use in an imaging apparatus, the consumable having a memory associated therewith, wherein an identifier associated with a user is stored in the memory, and wherein, in use, a system can use the identifier to distribute an offer to the user.

Yet another embodiment is directed to a method to provide a user with an offer for a used consumable, including associating the used consumable with the user, and if desired, providing an offer to the user related to the used consumable.

An advantage of some of the embodiments of the present invention is that a low overhead mechanism to encourage users to return their cartridges can be provided.

Another advantage of some of the embodiments of the present invention is that an offer, e.g., an incentive, can be provided to a user for the portion of imaging substance in a returned consumable that was not used.

### BRIEF DESCRIPTION OF THE DRAWINGS

The above-mentioned and other features and advantages of embodiments of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system that may be used in association with the present invention.

FIG. 2 is a graphical depiction of memory of a consumable that may be used in association with the present invention.

FIG. 3 is a block diagram depicting a system to provide a user with an offer related to an unused imaging substance in a consumable, in accordance with an embodiment of the present invention.

FIG. 4 is a flowchart of an exemplary method to provide a user with an offer related to an unused imaging substance in a consumable, in accordance with one embodiment of the present invention.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

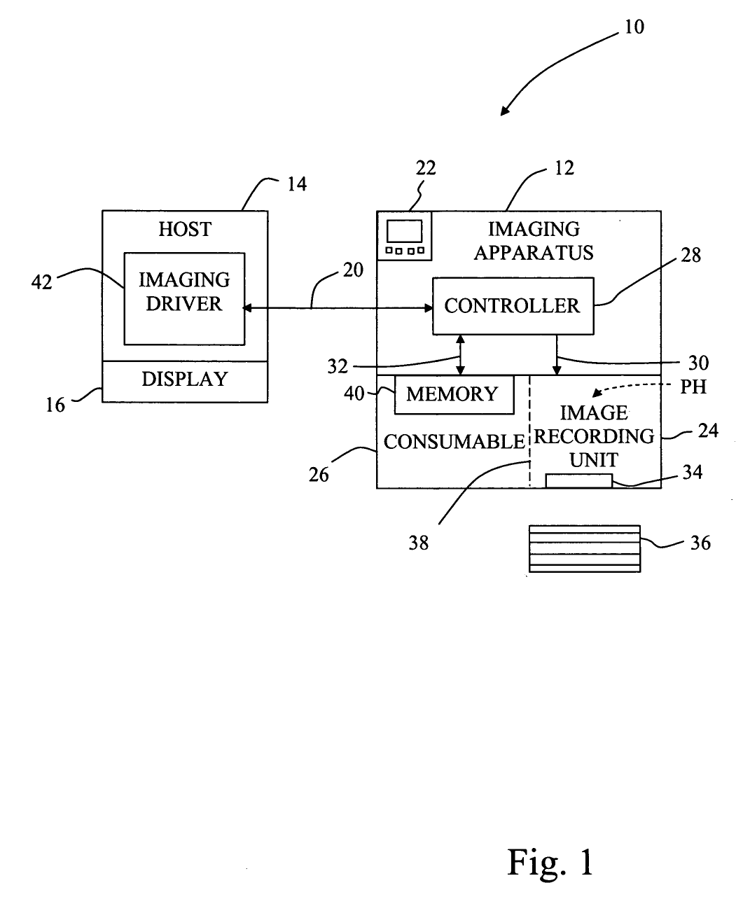

Referring now to the drawings, and particularly to FIG. 1, there is shown a diagrammatic depiction of an imaging system 10 that may be used in association with the present invention. System 10 includes an imaging apparatus 12 and a host 14. Imaging apparatus 12 communicates with host 14 via a communications link 20.

Imaging apparatus 12 includes a user interface 22, an image recording unit 24, a consumable 26 and a controller 28, which may be in the form of an Application Specific Integrated Circuit (ASIC). Controller 28 communicates with image recording unit 24 via a communications link 30. Controller 28 communicates with consumable 26 via a communications link 32.

Imaging apparatus 12 may be a conventional printer, or may form the print engine for a multi-function apparatus, such as for example, a standalone unit that has faxing and copying capability, in addition to printing, and which is sometimes referred to as an all-in-one (AIO) machine. Thus, imaging apparatus 12 may be, for example, an ink jet printer or an ink jet print engine in a multi-function apparatus, or may be an electrophotographic printer or an electrophotographic print engine in a multi-function apparatus.

In the context of the examples for imaging apparatus 12 given above, image recording unit 24 may be, for example, an ink jet printhead unit or an electrophotographic printing unit, and includes an imaging head 34 used for forming an image on a substrate 36, such as a sheet of print media or a photoconductive member. For convenience, each type of substrate 36 will be referred to by the element number 36, for example, print media 36.

Consumable 26 includes a supply of an imaging substance, such as ink or toner. For example, consumable 26 may be an ink supply tank, an ink jet printhead cartridge (PH), a toner tank, or an electrophotographic process (EP) cartridge, each of which containing a respective supply of ink or toner that is consumed during an imaging process. Further, consumable 26 may have a single reservoir that contains the imaging substance, or may include multiple reservoirs, each containing a different color of imaging substance.

Imaging apparatus 12 uses the imaging substance contained in consumable 26 to form an image on print media 36. Print media 36 may be, for example, sheets of paper, transparencies or fabric.

Those skilled in the art will recognize that image recording unit 24 and consumable 26 may be formed as individual discrete units, or may be combined in an integral unit, these options being depicted by dashed line 38. For example, in ink jet technology, such an integral unit may be an ink jet printhead cartridge PH including an ink reservoir and an ink jet printhead formed as a unitary consumable. Thus, for convenience, the term “consumable” is used to encompass either the discrete configuration or the integral configuration described above.

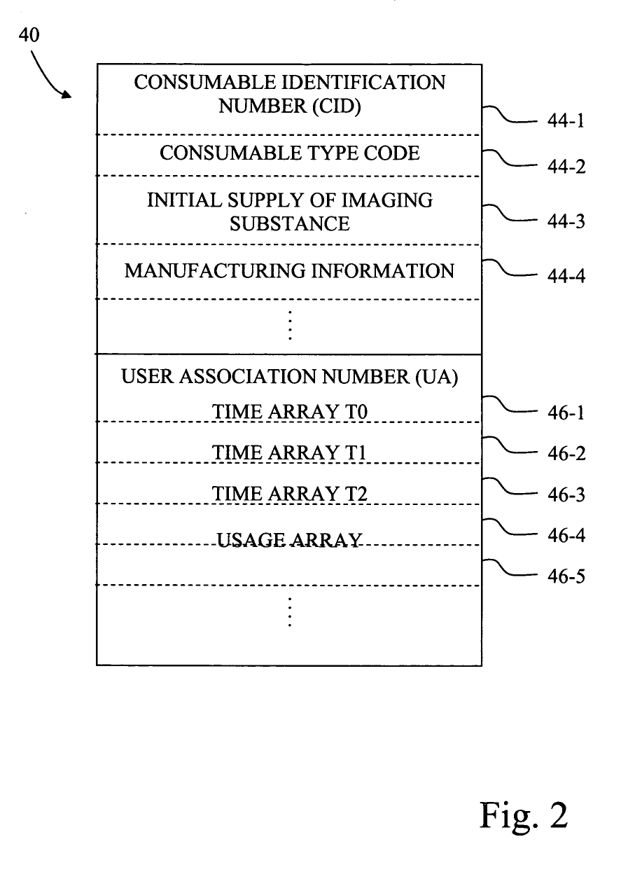

Consumable 26 has mounted thereto a memory 40 for storing information relating to consumable 26, more fully described below with respect to FIG. 2. In the case of ink jet printhead cartridge PH, for example, memory 40 may be formed on a part of the printhead silicon.

Host 14 may be, for example, a personal computer including a display device 16, an input device (e.g., keyboard), a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 42 for imaging apparatus 12. Imaging driver 42 is in communication with controller 28 of imaging apparatus 12 via communications link 20. Imaging driver 42 facilitates communication between imaging apparatus 12 and host 14, and provides formatted print data to imaging apparatus 12.

Communications link 20 may be established by a direct cable or optical connection, or by a network connection, such as for example an Ethernet local area network (LAN), and which may include an Internet connection. Communications links 30 and 32 may be established, for example, by using standard electrical cabling or bus structures, or by wireless connection.

FIG. 2 is a graphical depiction of memory 40, which for convenience is described as having a plurality of memory sections, namely, a memory section 44 that includes pre-programmed information generated during manufacturing, and a memory section 46 that is programmed with information when consumable 26 is installed in imaging apparatus 12 and during the use of imaging apparatus 12. Actual memory locations within the above described memory sections need not be contiguous.

Memory section 44 may include a plurality of memory locations, such as for example, memory locations 44-1, 44-2, 44-3 and 44-4. For example, in location 44-1 there may be stored a consumable identification number (CID); in location 44-2 there may be stored a consumable type code; in location 44-3 there may be stored an amount of an initial supply of imaging substance for consumable 26; and, in location 44-4 there may be stored other manufacturing information.

Memory section 46 also includes a plurality of memory locations, such as for example, memory locations 46-1, 46-2, 46-3, 46-4, and 46-5. For example, in location 46-1 there may be stored a user association number (UA) for consumable 26; in location 46-2 there may be stored a time array T0 for storing a time of initial installation of consumable 26 in imaging apparatus 12; in location 46-3 there may be stored a time array T1 for storing a time at which an imaging substance usage compensation algorithm is invoked; in location 46-4 there may be stored a time array T2 for storing a time at which it is predicted that, based on the imaging substance usage compensation algorithm, the available imaging substance supply will be depleted; and in location 46-5 there may be an array of usage bits that may be programmed to indicate the reaching of predetermined threshold levels of imaging substance consumption for consumable 26.

The user association number (UA) is a number that correlates a particular consumable 26 with a particular user. As used herein, the term “user” may include any person or entity associated with the purchase, lease or actual use of the consumable. The user association number (UA) may be, for example, a number selected by the user, a number selected by the manufacturer of consumable 26, a number generated by imaging apparatus 12, or the manufacturer's identification number assigned to imaging apparatus 12.

In accordance with some embodiments, if it is determined that the consumable 26 is defective or for some other reason has an unused amount of imaging substance remaining, the consumer may return consumable 26 to an establishment, such as for example, a retailer, a service department of a manufacturer, or a manufacturer authorized depository, to potentially receive an offer relating to the unused portion of the consumable. Moreover, for example, in some embodiments, if it is jointly determined by the user and the manufacturer that the consumable is defective, the user may simply call the service department of the manufacturer to receive the offer. The offer may be, for example, in the form of a partially filled replacement cartridge, a credit toward the purchase of a replacement cartridge, or a credit toward a future incentive or reward. In some embodiments, such cartridges and/or credits may be furnished to the user substantially immediately.

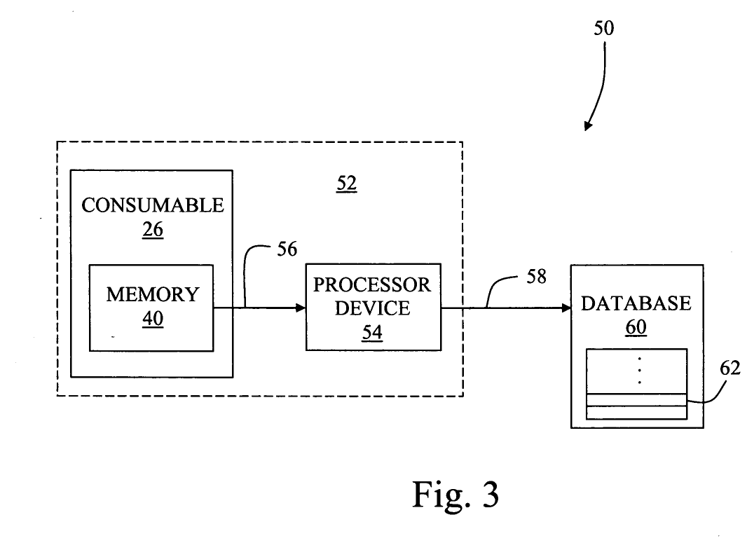

FIG. 3 is a block diagram depicting a system 50 to potentially provide a user with an offer related to an unused imaging substance in a consumable in accordance with one embodiment of the present invention. System 50 includes a fixture 52 for mechanically and electrically receiving consumable 26. Fixture 52 may be, for example, a dedicated tool or an imaging device, such as imaging device 12. Fixture 52 includes a processor device 54 communicatively coupled to memory 40 via a communications link 56. Processor device 54 executes program instructions to read memory 40 of consumable 26 to retrieve information pertinent to providing the user with the appropriate offer. For example, processor device 54 may access memory locations 44-1, 44-3, 46-1 and 46-5 to retrieve, respectively, the consumable identification number (CID), the initial supply of imaging substance in consumable 26, the user association number (UA), and the imaging substance usage information for consumable 26, from memory 40. From the initial supply of imaging substance information and imaging substance usage information, processor device 54 may determine an amount of imaging substance that remains in consumable 26.

Processor device 54 then forwards via communications link 58 the consumable identification number (CID), the user association number (UA), and the amount of remaining imaging substance in consumable 26 to a database 60.

Database 60 may include both processing and storage capabilities. Accordingly, database 60 may also make the determination of the amount of imaging substance remaining in consumable 26 based on the information from memory locations 44-3 and 46-5 provided by processor device 54.

If this is the first occurrence for the user, then database 60 can set up an initial file 62 for that user based on the user association number (UA), and associates with that user association number (UA) the consumable identification number (CID) and the amount of imaging substance in consumable 26. Database 60 then executes program instructions to determine the amount of value that will be potentially provided to the user.

If the file 62 is already set up in database 60 for the user association number (UA), then database 60 updates the current information in the user's file 62 with the new information associated the consumable identification number (CID) and the amount of imaging substance in consumable 26, and the amount of value that will be provided to the user may be determined based on the accumulated information in the user's file 62 in database 60. This may include, for example, usage information, such as time(s) since initial installation, the amount of remaining imaging substance in a consumable(s), and/or information pertinent to future operability of a consumable.

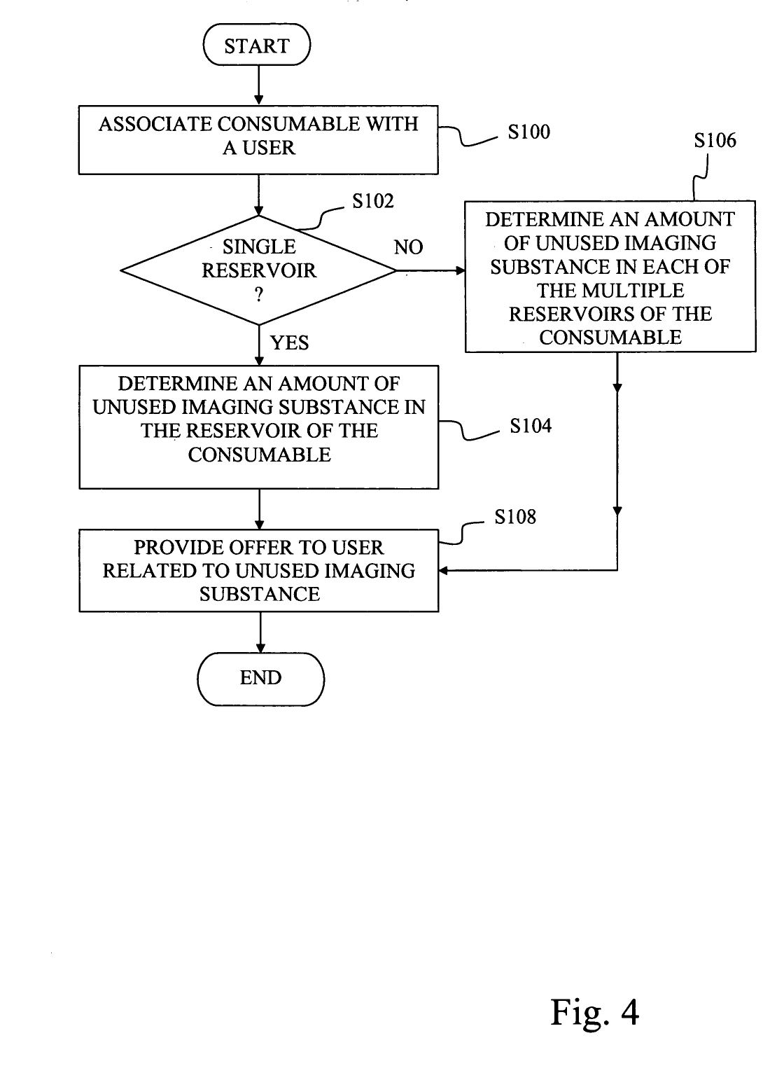

FIG. 4 is a flowchart of an exemplary method to potentially provide a user with an offer related to an unused imaging substance in a consumable, in accordance with one embodiment of the present invention. Each of the steps of the flowchart of FIG. 4 represent acts associated with the method.

At step S100, consumable 26 is associated with the user. Step S100 may be performed, for example, by fixture 52 described above with respect to FIG. 3, which reads memory 40 to retrieve the consumable identification number (CID) and the user association number (UA), which in turn forwards the information to database 60.

Alternatively, the user may register each consumable used with database 60 through an online registration procedure to associate the consumable with the user. This registration procedure may be a part of an incentive or rewards program implemented such that the program software executing on imaging apparatus 12 would automatically register the unique consumable identification number (CID) of the consumable with the current customer in database 60 via an Internet connection.

The user may also register the imaging apparatus, such as imaging apparatus 12, for the rewards program prior to participation in the rewards program. When imaging apparatus 12 is registered, database 60 will contain a unique user association number (UA), generated at the time of registration, and a unique printer ID generated at the time of printer manufacturing. When a new consumable, such as consumable 26, is installed in the registered printer, the printer will write either the unique user association number (UA) or the unique printer ID into memory 40. In turn, database 60 receives from imaging apparatus 12 and stores in database 60 the user association number or printer ID stored in memory 40 of consumable 26. Consumable 26 will be correlated with the user at database 60 when consumable 26 is submitted to the recipient, e.g., retailer, manufacturer, etc., by the user. In this method, the user might have explicitly agreed to communication between imaging apparatus 12 and database 60 at the time of registration by a verifiable event, such as through a check box or pushing a button.

At step S102, it is determined whether consumable 26 has a single reservoir, or has multiple reservoirs, such as for example, by reading the consumable type code in memory location 44-2 of memory 40 using fixture 52, and in turn the information maybe forwarded to database 60.

For example, if it is determined that the returned consumable 26 has a single reservoir, then at step S1104 an amount of unused imaging substance in that single reservoir is determined.

If, however, at step S102 it is determined that the returned consumable 26 has multiple reservoirs, then at step S106 the amount of unused imaging substance in each of the reservoirs of consumable 26 is determined, and then either the individual amounts may be maintained separately or may be added to form a cumulative amount.

Steps S104 and 106 may be performed, for example, by fixture 52, which reads memory 40 to retrieve the initial supply of imaging substance in consumable 26 and the usage array 46-5 and forward the information to database 60. Steps S104 and S106 may also be performed by measuring the amount of imaging substance in consumable 26, and forwarding the amount to database 60.

At step S108, if the manufacturer desires to, an offer can be provided to the user related to the unused imaging substance in consumable 108. In some embodiments, the manufacturer may desire to always provide an appropriate offer. In other embodiments, the manufacturer may desire to default to an application of judgment (whether automated or manually applied). The offer may be, for example, in the form of a partially filled replacement consumable, a credit toward the purchase of a replacement cartridge, or a credit toward a future incentive or reward. Credits may be, for example, in the form of a monetary discount. Incentives or rewards may be, for example, in the form of points, wherein the user is offered various incentives or rewards based upon the number of points accumulated.

For example, a partially filled replacement consumable yield may be approximately the same as the unused amount of imaging substance in an assumed defective consumable. The credit towards a future consumable may be applied to the current replacement consumable, or a future consumable, as desired by the user. The credit for a future reward may be implemented in conjunction with a program that gave rewards for other printing factors to the user, such as for example, based on a rate of consumption of consumables.

Considerable user convenience may be achieved by integrating the offer relating to the unused portion into a rewards program in which the user is already participating. With such a program, for example, the user of the consumable may only have to mail the consumable to the manufacturer and receive appropriate credit. Thus, the consumer's time either waiting in a return line at a retailer or calling the manufacturer's service department is saved.

Further, user incentive to help the environment may be achieved by encouraging users to return the consumable in a state that is conducive to reuse instead of recycling. For example, it is known that consumables degrade with time and with use when empty or near empty. Therefore, the user may be offered additional value in the form of credits or rewards for the timely return of a consumable that was not used after the accumulated imaging substance data in the usage array of memory location 46-5 indicates empty, or some other usage level event. The timeliness of the return can be determined by fixture 52 and/or database 60 through reading the accumulated time T2 stored in the memory location 46-4 of memory 40. Alternatively, a rewards software program could provide an installation and completion date to database 60.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method to provide a user with an offer related to an unused imaging substance in a consumable, comprising:
associating said consumable with said user;
determining an amount of unused imaging substance in said consumable; and
if desired, providing an offer to said user relating to said unused imaging substance in said consumable.

2. The method of claim 1, wherein said offer is a credit to said user.

3. The method of claim 1, wherein said offer is a reward to said user.

4. The method of claim 1, wherein said offer is an incentive to said user.

5. The method of claim 1, wherein said imaging substance is one of ink and toner.

6. The method of claim 1, wherein said consumable has a memory associated therewith, and wherein the act of associating said consumable with said user includes reading said memory to retrieve a consumable identification number and a user association number.

7. The method of claim 1, wherein the act of associating said consumable with said user includes said user registering said consumable with a database using a consumable identification number of said consumable.

8. The method of claim 1, wherein the act of associating said consumable with said user includes:
providing a rewards program for an imaging apparatus registered in a database;
receiving at said database from said imaging apparatus a user association number stored in a memory of said consumable by said imaging apparatus; and
correlating said consumable with said user association number received at said database when said consumable is submitted by said user.

9. The method of claim 1, wherein if said consumable has multiple reservoirs, then the act of determining an amount of unused imaging substance in said consumable includes determining individual amounts of said imaging substance for each reservoir.

10. The method of claim 9, wherein said individual amounts of said imaging substance are added to form a cumulative amount.

11. The method of claim 1, wherein the act of determining an amount of unused imaging substance in said consumable includes measuring said amount of imaging substance in said consumable, and forwarding said amount to a database.

12. The method of claim 1, wherein prior to the act of associating said consumable with said user, said method further comprising receiving said consumable from said user.

13. A system to provide a user with an offer relating to unused imaging substance in a consumable having a memory, comprising:
a fixture configured for receiving said consumable, said fixture having a processor device communicatively coupled to said memory of said consumable, said processor device executing program instructions to retrieve information pertinent to providing to said user said offer relating to said unused imaging substance in said consumable; and
a database communicatively coupled to said processor device for receiving said information from said processor device.

14. The system of claim 13, wherein said information includes a consumable identification number.

15. The system of claim 13, wherein said information includes imaging substance usage information associated with said consumable.

16. The system of claim 13, wherein said database executes program instructions to determine an amount of value associated with the offer that will be provided to said user based on said unused imaging substance in said consumable.

17. The system of claim 13, wherein said amount of value associated with the offer that will be provided to said user is determined based on accumulated information in a file in said database associated with said user.

18. A consumable for use with an imaging apparatus, the consumable having a memory associated therewith, wherein data associated with a user is stored in said memory, and wherein, in use, a system can use said data to distribute an offer to said user.

19. The consumable of claim 18, wherein said data is a user association number.

20. The consumable of claim 18, wherein said consumable is an ink jet printhead cartridge, said memory being integral with a printhead of said printhead cartridge.

21. A method to provide a user with an offer relating to a used consumable, comprising:
associating said used consumable with said user; and
if desired, providing an offer to said user relating to said used consumable.

22. The method of claim 21, wherein said offer is based, at least in part, on an amount of unused imaging substance in said used consumable.

23. The method of claim 21, wherein the offer is based, at least in part, on information pertinent to future operability of the used consumable.

24. The method of claim 21, wherein the offer is based, at least in part, on information related to time since initial installation of the used consumable.

25. The method of claim 21, wherein the offer is based, at least in part, on usage information associated with the used consumable.

26. The method of claim 21, wherein an accumulated time is stored in memory associated with the used consumable.
